(19) United States
(12) Patent Application Publication
(10) Pub. No.: US 2015/0334355 A1
(43) Pub. Date: Nov. 19, 2015

(54) SYSTEM FOR ASSET MANAGEMENT

(71) Applicant: SCHNEIDER ELECTRIC IT CORPORATION, West Kingston,, RI (US)

(72) Inventors: Gary R. Ware, Newton, MA (US); Christophe Charles Oliver, Dover, MA (US)

(73) Assignee: SCHNEIDER ELECTRIC IT CORPORATION, West Kingston, RI (US)

(21) Appl. No.: 14/655,108

(22) PCT Filed: Dec. 27, 2012
(86) PCT No.: PCT/US2012/071864

§ 371 Date: Jun. 24, 2015

(51) Int. Cl. H04N 7/18; G06K 9/62; G06K 9/52; G06K 9/46

(52) U.S. Cl. CPC H04N 7/183; G06K 9/46; G06K 9/6215; G06K 9/4661; G06K 9/52

(57) ABSTRACT

A system for managing devices in a data center includes an equipment rack configured to house the devices, and one or more cameras mounted on the equipment rack. The one or more cameras are configured to capture one or more images of the devices. The system also includes a processor coupled to the one or more cameras configured to receive the one or more images of the devices, identify, from the one or more images, information relating to at least one of the devices, and transmit the information to an external device.

### BACKGROUND

In response to the increasing demands of information-based economies, information technology networks continue to proliferate across the globe. This expansion has taken on various forms including widely distributed computer networks, which link together geographically disparate computing resources, and centralized network data centers, which provide shared power, cooling and telecommunication infrastructure to a host of collocated network devices. As the kind, size and complexity of these information technology networks grow, so do the costs associated with their operation. These costs include the cost of acquiring network devices and infrastructure, the cost of the power consumed by the network devices and cooling systems, and the salary of network administration staff.

As the magnitude of the costs associated with information technology networks has increased, so has the market's focus on enabling organizations to better manage them. Datacenters often include multiple equipment racks holding multiple servers or other computer equipment. Managers of data centers attempt to keep track of where each server is located in the datacenter to allow access to a specific server, for example in case of a server crash. However, servers and other computer equipment may be moved around the datacenter, and conventional tracking systems are typically manually updated, which frequently results in errors. Computer equipment may be difficult to locate if there are errors or delays in updating a manual tracking system, and the recorded location for a selected piece of equipment is incorrect. Also, more accurately tracking equipment can provide information on resource use and availability.

### SUMMARY

According to one aspect, a system for managing devices in a data center includes an equipment rack configured to house the devices, and one or more cameras mounted on the equipment rack. The one or more cameras are configured to capture one or more images of the devices. The system also includes a processor coupled to the one or more cameras configured to receive the one or more images of the devices, identify, from the one or more images, information relating to at least one of the devices, and transmit the information to an external device.

In some embodiments, the one or more images of the devices include one or more quick response (QR) codes encoding the information relating to at least one of the devices.

In some embodiments, the information relating to at least one of the devices includes a location for each of the at least one of the devices.

In some embodiments, the information relating to at least one of the devices includes identifying information for each of the at least one of the devices.

In some embodiments, the processor is further configured to receive a first and a second set of one or more images of the devices, detect differences between the first and the second set of one or more images of the devices, and transmit the detected differences to the external device.

In some embodiments, the cameras are configured to capture the first set of one or more images as a door of the equipment rack is opened, and capture the second set of one or more images as the door of the equipment rack is closed.

In some embodiments, the cameras are configured to capture the first and second sets of one or more images when the door of the equipment rack is at a relatively same angle with respect to a front plane of the equipment rack.

In some embodiments, the system further includes a light-emitting diode coupled to the door of the equipment rack, the light-emitting diode configured to emit a beam of light while the door is ajar, a reflective article coupled to a frame of the equipment rack, and a photo detector coupled to the processor. The photo detector is configured to detect light emitted from the light-emitting diode and reflected off of the reflective article when the door is at the relatively same angle with respect to the front plane of the equipment rack, and transmit a signal to the processor indicating that the first or second set of one or more images are to be captured.

According one aspect, a rack mountable monitoring system includes a strip of material configured to be detachably mounted on a door of an equipment rack, one or more cameras mounted on the strip of material, the one or more cameras configured to capture one or more images of devices housed by the equipment rack, and a processor coupled to the one or more cameras. The processor is configured to receive the one or more images of the devices, identify, from the one or more images, information relating to at least one of the devices, and transmit the information to an external device.

According to one aspect, a method of managing devices in a data center includes capturing, with one or more cameras mounted on an equipment rack, one or more images of devices housed in the equipment rack, receiving, by a processor coupled to the one or more cameras, the one or more images of the devices, identifying, from the one or more images, information relating to the at least one of the devices, and transmitting the information to an external device.

### BRIEF DESCRIPTION OF THE FIGURES

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of an example inventory management system;

FIG. 2 is a perspective view of a portion of an equipment rack;

FIG. 3 is an enlarged perspective view of a portion of an equipment rack;

FIG. 4 is a front view of a portion of an equipment rack;

FIG. 5A is a cross-sectional schematic diagram of one embodiment of the of the present disclosure;

FIG. 5B is a diagram of a portion of one embodiment of the of the present disclosure; and

FIG. 6 is a conceptual diagram of an equipment rack in accordance with at least one embodiment of the present disclosure.

### DETAILED DESCRIPTION

Embodiments of this invention are not limited in their application to the details of construction and the arrangement of components set forth in the following description or illustrated in the drawings. Embodiments of the invention are capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items. Any references to front and back, left and right, and top and bottom, are intended for convenience of description, not to limit the present systems and methods or their components to any one positional or spatial orientation.

Asset inventory and management systems are used in many organizations to track and control information technology resources in both centralized and distributed installations. Many companies house servers, telecommunications equipment and the like in numerous equipment racks within data centers. In some embodiments, inventory of these assets is managed through the use of multiple cameras attached to the equipment racks. The cameras are used to read bar codes or quick response (QR) codes on the equipment. The cameras can also be used to detect changes on equipment racks, which may reflect an addition or removal of an asset from the rack. In some embodiments, the cameras on each equipment rack are connected to one or more processors. The processors analyze the images captured by the cameras to read the QR codes and transmit the information to a computer system via a network. The computer system can receive such information from each of the numerous equipment racks and provide a centralized inventory management system.

According to some embodiments, a QR code may be used to identify an asset based on identifying information (e.g., asset identifying information, properties of the asset, network addressing, or power requirements of the asset) contained in the QR code. The identifying information may be preset at the factory, or it may be defined by the user. The QR code can be placed on the front of the asset and detected by cameras attached to the door of the equipment rack.

According to some embodiments, the processor or central computer system may use the identifying information to compare against properties of the asset in a database, or in a user-programmed set of control commands. The properties may include, for example, a set of control actions, access permissions, load availability, and billing data. The computer system may log the data to a database or other storage device, and may track and send the information regarding the asset (e.g., properties, status, and load) to other devices (e.g. Data Center Information Management Systems) for uses such as billing, asset management, power control, and asset traceability. The database can be user-defined to store data fields corresponding to user-defined QR codes.

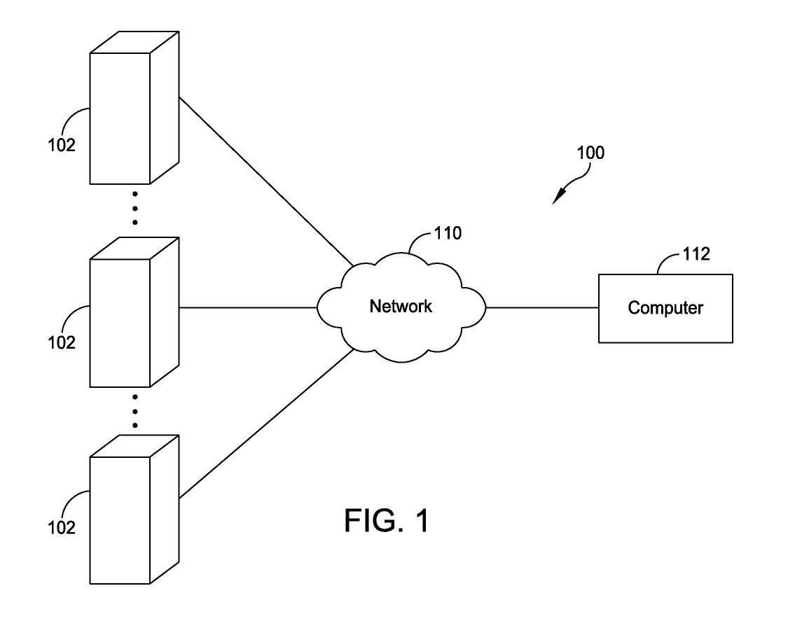

FIG. 1 shows an example inventory management system 100. In some embodiments, the inventory management system 100 includes one or more equipment racks 102. The equipment racks 102 are connected to a network 110, which is connected to one or more computer systems 112.

In some embodiments, the equipment racks 102 include one or more cameras attached to the equipment racks 102. For example, each equipment rack 102 can include a plurality of cameras attached to a front door of the equipment rack 102. The cameras can be positioned to generate images of assets installed in the equipment rack 102. The assets can have QR codes attached to the fronts of the assets. For example, QR codes can be printed and stuck with adhesive on to each of the assets. In some embodiments assets can be manufactured to include QR codes.

Each QR code includes information regarding the asset on which the QR code is attached. In some embodiments, the information includes data such as a unique identifier of the asset, a model number of the asset, a serial number of the asset, a functional type of the asset, power requirements of the asset, network addresses of the asset, other resource requirements of the asset, a height measurement of the asset (e.g., measured in unit (U) spaces) and other properties related to the asset.

The network 110 can be, among other types of networks, a private network (such as a LAN, WAN, extranet, or intranet) or may be a public network (such as the internet). In some embodiments, the computer system 112 includes a data center inventory management module which receives data from the equipment racks 102. The computer system 112 can include a database and/or other information storage system to track the locations and properties of assets in the equipment racks 102 based on the information received from the equipment racks 102. For example, the computer system 112 can include a centralized data center configuration and control manager, such as InfraStruXure® Central Server, Model Number AP9475, available from APC by Schneider Electric of West Kingston, RI. In another example, the computer system 112 can include one or more devices, interconnected through the network 110 and/or a different network, of a distributed processing system configured to manage IT assets.

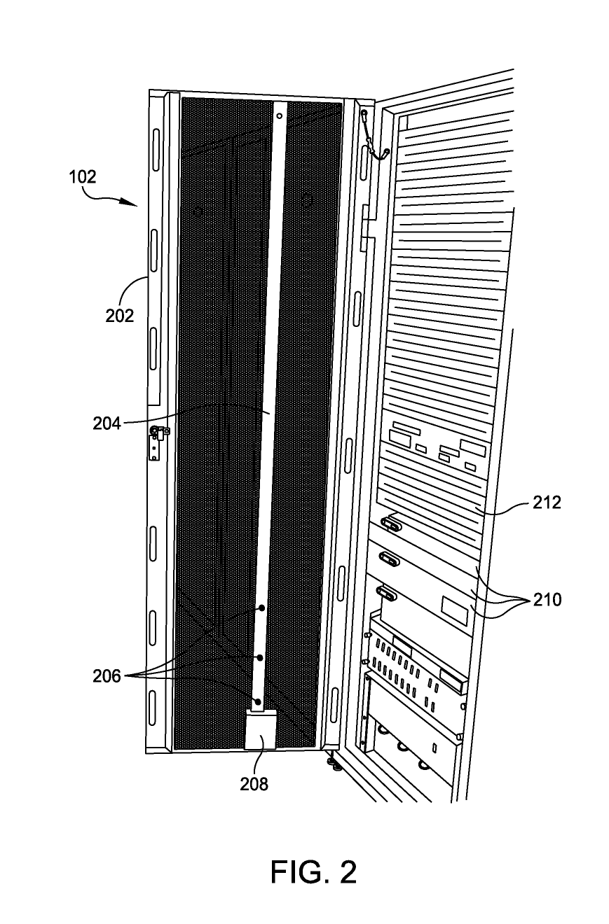

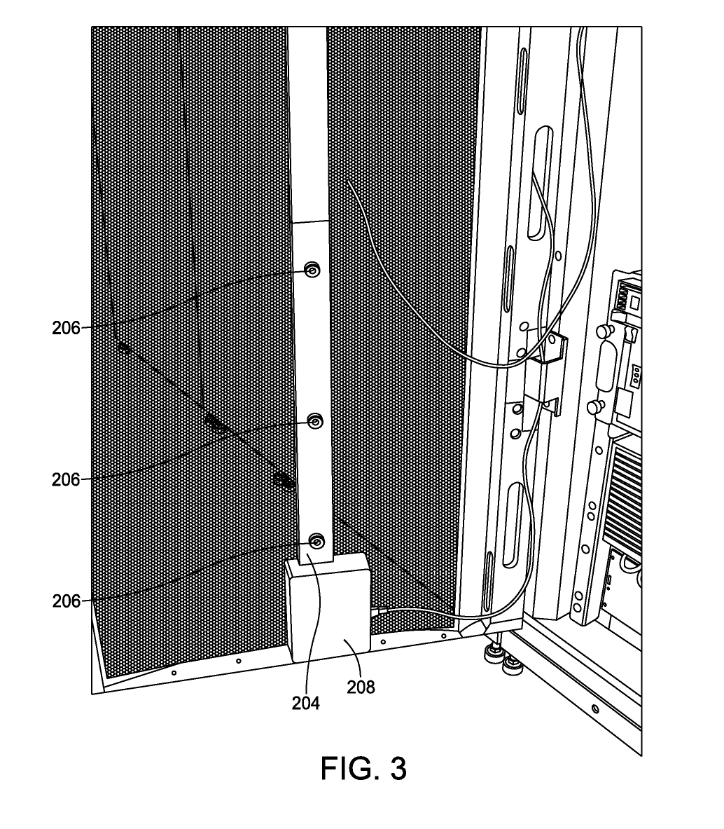

Referring also to FIGS. 2, 3, and 4, in some embodiments, a front door 202 of the equipment rack 102 includes a strip 204 on the inside of the front door 202. The strip 204 can be detachably coupled to the front door 202. The strip 204 includes one or more cameras 206 and a processor 208. The equipment rack 102 is configured to hold assets 210. U spaces that are not holding assets 210 are empty spaces available for future installation of assets 210. Such empty spaces can be covered with blanking panels 212.

The strip 204 can be made of metal, plastic, or other appropriate material, or a combination of appropriate materials. The strip 204 can be between 0.5 inches and 3 inches (e.g., 1 to 1.5 inches) wide and between 0.25 and 1 inch (e.g., 0.5 inches) thick. In some embodiments, the width of the strip 204 is minimized to minimize obstruction of airflow into the equipment rack 102. In some embodiments, the thickness of the strip 204 is determined so that the strip 204 does not contact the assets 210 installed in the equipment rack 102 when the front door 202 is closed. The thickness can also be minimized to allow for a wider field of view for the cameras 206. The strip 204 can have the same height as the front door 202. In some embodiments, the height of the strip is between 42 and 52 U spaces, equal to between 73.5 and 91 inches.

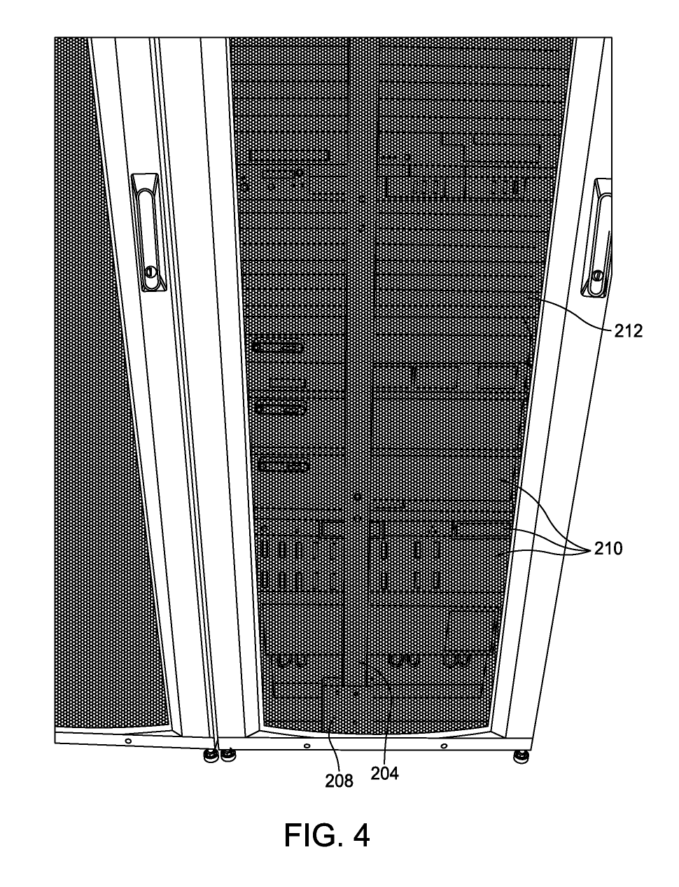

The strip 204 includes one or more cameras 206. In some embodiments, the cameras 206 are spaced at regular intervals, such as every 6 inches or every 3 U spaces. In some embodiments, the cameras 206 generate images of the assets 210, for example, by taking pictures when the front door 202 of the equipment rack 102 is closed, as shown in FIG. 4. The images can be captured at periodic intervals, for example, on a schedule set by a user, and/or on request. The processor 208 receives the images and detects QR codes found in the image. For example, an image can be a picture of the assets 210 in a field of view of the camera 206. QR codes can be attached to the assets 210 in the field of view and detected by the processor 208. The processor 208 can decipher the information embedded in each QR code to extract information related to the assets 210. In some embodiments, the blanking spaces 212 also include QR codes identifying the blanking spaces 212.

In some embodiments, the processor 208 also receives information about the camera 206. For example, the processor 208 can receive information related to the position of the camera 206. Using the position information of the camera 206, the processor 208 can determine the position of the assets 210 within the equipment rack 102 shown in any of the images generated by the camera 206. In some embodiments, the processor 208 receives and process images from the cameras 206 in a sequential order, such as from the camera 206 located closest to the top of the strip 204 to the camera 206 located closest to the bottom of the strip 204. The processor 208 can use the sequence information to determine the position of the assets 210 in the received images. The processor 208 can also use the U space height information included in the QR codes to determine the position of the assets 210 and to determine if all U spaces are accounted for.

In some embodiments, the processor 208 sends the information to the computer system 112 via the network 110. The processor 208 can be connected to the network 110 via Ethernet or other protocol. In some embodiments, the processor 208 stores information in a database of the assets 210 in the equipment rack 102. The processor 208 can transmit the database to the computer system 112, and/or transmit changes in the database. For example, if the processor 208 determines no changes have been made to the assets 210 in the equipment rack 102, the processor 208 can transmit a message to the computer system 112 indicating that the assets 210 in the equipment rack 102 have not changed. In some embodiments, the processor 208 only transmits information when changes are detected. Also, in some embodiments, the processor 208 can acquire and transmit a new set of images based on a request from the computer system 112.

The computer system 112 can receive such information from a plurality of equipment racks 102 in one or more data centers. The information can be used to track the locations of the assets 210 in the data centers. The computer system 112 can also use the information to provide recommendations and/or reports for installing new assets. For example, algorithms can be used to optimize resource usage. For example, minimizing empty U spaces on an equipment rack can optimize data center space.

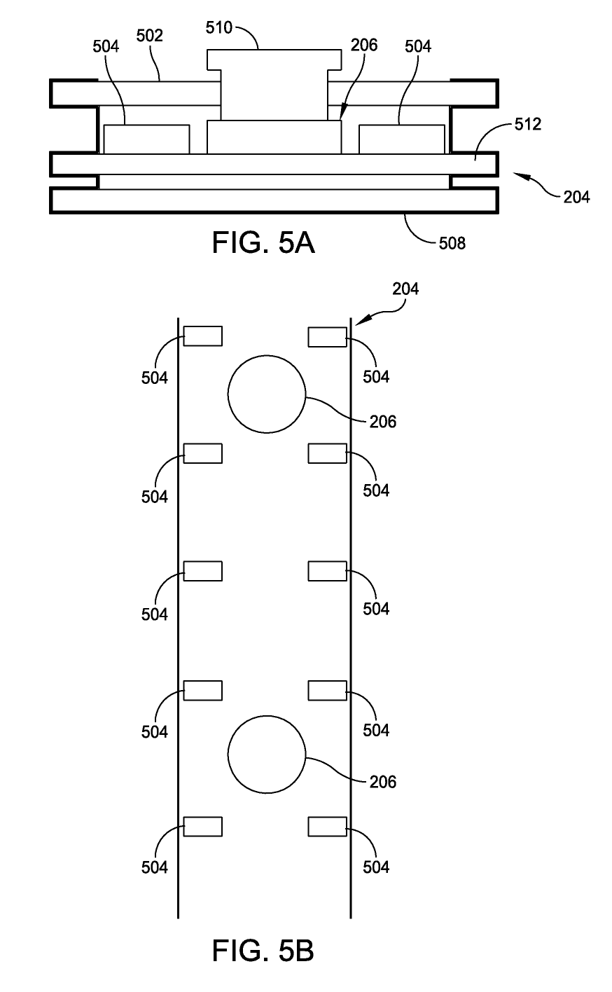

Referring to FIGS. 5A and 5B, in some embodiments, the strip 204 is an aluminum extrusion 1.25 inches wide and 0.5 inches thick with three grooves. A diffuser 502 is fitted into an inside groove. The camera 206 includes a lens 510 and a printed circuit board (PCB) 512. The PCB 512 is fitted into a middle groove. The PCB 512 also includes one or more light emitting diodes (LEDs) 504 coupled to the PCB 512. A steel bar 508 is fitted into an outside groove. In some embodiments, the strip 204 is made of sectioned pieces. For example, the strip 204 can consist of four 18-inch sections. Each section can be interconnected using the steel bar 508. In some embodiments, each steel bar 508 is 1.25 inches wide and 4 inches tall. The steel bar 508 is fitted 2 inches into each section. The steel bar 508 can be fastened by a screw in each section. The sections can interconnect electrically with right angle connectors. The strip 204 can include a base section, which includes the processor 508, and multiple extension sections.

In some embodiments, the strip 204 can be coupled to doors of equipment racks 102 with a plastic snap-in fastener. The base section includes an Ethernet port and can receive both power and network connectivity via an Ethernet cable.

In some embodiments, the strip 204 includes LEDs 504 or other appropriate light source. The LEDs 504 provide light for the cameras 206 to capture the images of the assets 210. The LEDs 504 can be configured to turn on when the cameras 206 capture images. For example, several LEDs 504 closest to the camera 206 taking a picture can turn on when the camera 206 takes the picture and turn off afterwards. In some embodiments, all the LEDs 504 turn on for each camera 206. In some embodiments, the LEDs 504 remain on for a majority of the time.

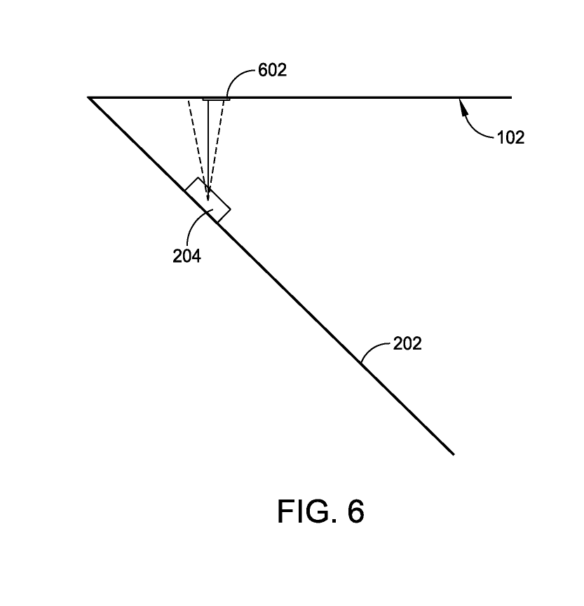

Referring to FIG. 6, in some embodiments, the cameras also capture images of the assets in the equipment rack 102 when the front door 202 is opened and closed. In some embodiments, installation and/or removal of assets from the equipment rack 102 are likely accompanied by a opening and closing of the front door 202. The cameras can be configured to capture one or more images as the door 202 is opened and capture one or more images as the door 202 is closed. The processor 208 can compare the captured images to detect differences in the images. The differences can reflect a change in the assets in the equipment rack 102. The processor 208 can transmit images where differences are detected to the inventory management computer system. The computer system can further analyze the images and/or a user can examine the images to determine changes in the assets of the equipment rack 102. In some embodiments, the processor 208 can transmit both images between which a difference is detected. In some embodiments, the processor 208 can transmit portions of images where differences are detected. In some embodiments, the processor 208 can transmit the later-captured image or portions of the later-captured image.

In some embodiments, the processor 208 can more closely analyze portions of images that are determined to have changed. The processor 208 can analyze for QR codes in the portions to determine added or removed assets. In some embodiments, the processor 208 can be trained to identify assets with or without QR codes, using known image processing techniques.

In some embodiments, the images are captured by the cameras when the door 202 is at a predetermined angle with respect to a front face of the equipment rack 102. By capturing images at a substantially consistent angle, the differences between images can more accurately reflect additions and removals of assets. In some embodiments, one or more cameras can be configured in the strip 204 at an angle such that the images captured when the door 202 is open provides for more direct-facing images. In some embodiments, a reflective tape 602 is attached to the equipment rack 102 at a predetermined location (e.g., 5-6 inches from a hinge of the door 202). The strip 204 includes an LED or other light emitting device and a photo detector. The LED can emit a narrow beam of light which hits the reflective tape 602 at a 90 degree angle when the door 202 is at the predetermined angle. The photo detector can receive the reflected light and send a signal to the processor 208. The processor 208 can use the signal as a trigger to instruct the cameras to capture the images. In some embodiments, the images captured with the door 202 open provides a wider field of view of the assets in the equipment rack 102. For example, in some embodiments the angle can be predetermined such that the entire width of the equipment rack 102 can be captured in the images.

In some embodiments, the light reflected off of the reflective tape 602 triggers the capturing of images both as the door 202 is opened and then as the door 202 is closed. The processor 208 can use a proximity of timestamps of the sets of images to determine how long the door was opened and whether or not the images should be compared to determine differences. In some embodiments, the processor 208 can always compare the last two sets of captured images. In some embodiments, more than one LED or reflective tape can be used to further determine whether the door 202 is being opened or closed to determine whether captured images should be compared.

In some embodiments, the strip 204 also includes one or more temperature sensors and/or humidity sensors coupled to the processor 208. In some embodiments, the processor 208 may communicate temperature and/or humidity measurements to the computer system 112. In some embodiments, the strip 204 is mounted on horizontal tracks at the top and bottom of the door 202 that allows the strip 204 to move from side to side across the width of the door. The cameras can then capture images and detect QR codes placed anywhere on the assets. In some embodiments, the cameras are 3 megapixel cameras capturing images of 6 inches by 4 inches on the assets. The QR codes are 29 dots square and about 0.5 inch squares.

The images and data extracted from the images may be configured to provide recommendations for optimal configuration of power or network connections of attached equipment and other recommendations as described herein. Embodiments may include utilizing communication methods from external devices. Such external devices may include rack power distribution units (PDUs), other hardware (e.g., remote power panels or feeder PDUs), and/or other external software, such as Infrastruxure Central, discussed above, or third party applications to provide user recommendations and/or calculated data based on the external information and the data collected by the processor 208. Methods to transmit data to remote locations via an embedded web interface, SNMP, IPMI, serial, or any other communication method of the information processed in the processor 208 to other devices may further be provided.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. For example, alternative configurations of electrical components may be utilized to produce similar functionality, for example, transceiver functions, or other functions. Accordingly, the foregoing description and drawings are by way of example only.

What is claimed is:

1. A system for managing devices in a data center, comprising:
an equipment rack configured to house the devices;
one or more cameras mounted on the equipment rack, the one or more cameras configured to capture one or more images of the devices; and
a processor coupled to the one or more cameras configured to:
receive the one or more images of the devices;
identify, from the one or more images, information relating to at least one of the devices; and
transmit the information to an external device.

2. The system of claim 1, wherein the one or more images of the devices comprises one or more quick response (QR) codes encoding the information relating to at least one of the devices.

3. The system of claim 1, wherein the information relating to at least one of the devices comprises a location for each of the at least one of the devices.

4. The system of claim 1, wherein the information relating to at least one of the devices comprises identifying information for each of the at least one of the devices.

5. The system of claim 1, wherein the processor is further configured to:
receive a first and a second set of one or more images of the devices;
detect differences between the first and the second set of one or more images of the devices; and
transmit the detected differences to the external device.

6. The system of claim 5, wherein the cameras are configured to:
capture the first set of one or more images as a door of the equipment rack is opened; and
capture the second set of one or more images as the door of the equipment rack is closed.

7. The system of claim 6, wherein the cameras are configured to capture the first and second sets of one or more images when the door of the equipment rack is at a relatively same angle with respect to a front plane of the equipment rack.

8. The system of claim 7, further comprising:
a light-emitting diode coupled to the door of the equipment rack, the light-emitting diode configured to emit a beam of light while the door is ajar;
a reflective article coupled to a frame of the equipment rack; and
a photo detector coupled to the processor and configured to:
detect light emitted from the light-emitting diode and reflected off of the reflective article when the door is at the relatively same angle with respect to the front plane of the equipment rack; and
transmit a signal to the processor indicating that the first or second set of one or more images are to be captured.

9. A rack mountable monitoring system comprising:
a strip of material configured to be detachably mounted on a door of an equipment rack;
one or more cameras mounted on the strip of material, the one or more cameras configured to capture one or more images of devices housed by the equipment rack; and
a processor coupled to the one or more cameras configured to:
receive the one or more images of the devices;
identify, from the one or more images, information relating to at least one of the devices; and
transmit the information to an external device.

10. The rack mountable monitoring system of claim 9, wherein the one or more images of the devices comprises one or more quick response (QR) codes encoding the information relating to at least one of the devices.

11. The rack mountable monitoring system of claim 9, wherein the information relating to at least one of the devices comprises a location for each of the at least one of the devices.

12. The rack mountable monitoring system of claim 9, wherein the strip of material is configured to be detachably coupled to one or more other strips of material comprising one or more other cameras mounted on the one or more other strips of material.

13. The rack mountable monitoring system of claim 12, wherein the one or more other cameras are configured to communicate with the processor.

14. The rack mountable monitoring system of claim 9, wherein the processor is further configured to:
receive a first and a second set of one or more images of the devices;
detect differences between the first and the second set of one or more images of the devices; and
transmit the detected differences to the external device.

15. A method of managing devices in a data center, comprising:
capturing, with one or more cameras mounted on an equipment rack, one or more images of devices housed in the equipment rack;
receiving, by a processor coupled to the one or more cameras, the one or more images of the devices;
identifying, from the one or more images, information relating to the at least one of the devices; and
transmitting the information to an external device.

16. The method of claim 15, wherein capturing one or more images of the devices comprises capturing one or more images of one or more quick response (QR) codes encoding the information relating to at least one of the devices.

17. The method of claim 15, wherein identifying information relating to at least one of the devices comprises identifying a location for each of the at least one of the devices.

18. The method of claim 15, wherein identifying information relating to at least one of the devices comprises identifying information for each of the at least one of the devices.

19. The method of claim 15, further comprising:
receiving a first and a second set of one or more images of the devices;
detecting differences between the first and the second set of one or more images of the devices; and
transmitting the detected differences to the external device.

20. The method of claim 19, further comprising:
capturing the first set of one or more images as a door of the equipment rack is opened; and
capturing the second set of one or more images as the door of the equipment rack is closed.
